(19) United States
(12) Patent Application Publication
(10) Pub. No.: US 2003/0010839 A1
(43) Pub. Date: Jan. 16, 2003

(54) Water and air spray system

(76) Inventor: Donovan Davis, Newburgh, NY (US)

Correspondence Address: Richard W. Goldstein, 2071 Clove Road, Staten Island, NY, 10304, US

(21) Appl. No.: 09/901,775

(22) Filed: Jul. 10, 2001

(51) Int. Cl. A01G 25/09

(52) U.S. Cl. 239/146; 239/172

(57) ABSTRACT

A water and air spray system including a support stand adapted for being positioned on a recipient surface. An air pump is positioned adjacent to the support stand. The air pump has a water inlet and an air inlet. The air pump has a water and air outlet. A bottle of sterilized water is adapted for being removably coupled with the upper hooked support portion of the support stand. The bottle of sterilized water has a drain line extending outwardly therefrom for coupling with the water inlet of the air pump. A disposable spray control is adapted for spraying water and air therefrom. The disposable spray control has a coupling line removably coupled therewith. The coupling line has a free end coupled with the water and air outlet of the air pump.

### BACKGROUND OF THE INVENTION

The present invention relates to a water and air spray system and more particularly pertains to allowing sterilized water to be sprayed during a dental procedure.

The use of dental accessory devices is known in the prior art. More specifically, dental accessory devices heretofore devised and utilized for the purpose of facilitating a dental procedure are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,340,366 to Heil discloses a combination dental hand piece with an air and water spray system. U.S. Pat. No. 4,017,974 to Sotman discloses a dental hand piece with means to adjust the spray of water. U.S. Pat. No. 5,624,636 to Schwartz discloses a hydrochlorated base disinfectant for cleaning dental impressions.

While these devices fulfill their respective, particular objective and requirements, the aforementioned patents do not describe a water and air spray system for allowing sterilized water to be sprayed during a dental procedure.

In this respect, the water and air spray system according to the present invention substantially departs from the conventional concepts and designs of the prior art, and in doing so provides an apparatus primarily developed for the purpose of allowing sterilized water to be sprayed during a dental procedure.

Therefore, it can be appreciated that there exists a continuing need for a new and improved water and air spray system which can be used for allowing sterilized water to be sprayed during a dental procedure. In this regard, the present invention substantially fulfills this need.

### SUMMARY OF THE INVENTION

In the view of the foregoing disadvantages inherent in the known types of dental accessory devices now present in the prior art, the present invention provides an improved water and air spray system. As such, the general purpose of the present invention, which will be described subsequently in greater detail, is to provide a new and improved water and air spray system which has all the advantages of the prior art and none of the disadvantages.

To attain this, the present invention essentially comprises a support stand adapted for being positioned on a recipient surface. The support stand has a lower base portion and an upper hooked support portion. The support stand includes a plurality of eyelets secured thereto in a spaced relationship extending a length thereof. An air pump is positioned adjacent to the lower base portion of the support stand. The air pump has a water inlet and an air inlet. The air pump has a water and air outlet. A bottle of sterilized water is adapted for being removably coupled with the upper hooked support portion of the support stand. The bottle of sterilized water has a drain line extending outwardly therefrom for coupling with the water inlet of the air pump. A disposable spray control is adapted for spraying water and air therefrom. The disposable spray control has a coupling line removably coupled therewith. The coupling line has a free end coupled with the water and air outlet of the air pump.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved water and air spray system which has all the advantages of the prior art dental accessory devices and none of the disadvantages.

It is another object of the present invention to provide a new and improved water and air spray system which may be easily and efficiently manufactured and marketed.

It is a further object of the present invention to provide a new and improved water and air spray system which is of durable and reliable construction.

An even further object of the present invention is to provide a new and improved water and air spray system which is susceptible of a low cost of manufacture with regard to both materials and labor, and which accordingly is then susceptible of low prices of sale to the consuming public, thereby making such a water and air spray system economically available to the buying public.

Even still another object of the present invention is to provide a new and improved water and air spray system for allowing sterilized water to be sprayed during a dental procedure.

Lastly, it is an object of the present invention to provide a new and improved water and air spray system including a support stand adapted for being positioned on a recipient surface. An air pump is positioned adjacent to the support stand. The air pump has a water inlet and an air inlet. The air pump has a water and air outlet. A bottle of sterilized water is adapted for being removably coupled with the upper hooked support portion of the support stand. The bottle of sterilized water has a drain line extending outwardly therefrom for coupling with the water inlet of the air pump. A disposable spray control is adapted for spraying water and air therefrom. The disposable spray control has a coupling line removably coupled therewith. The coupling line has a free end coupled with the water and air outlet of the air pump.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the water and air spray system constructed in accordance with the principles of the present invention.

FIG. 2 is a side view of the present invention illustrating the disposable dental hand piece thereof.

FIG. 3 is a side view of the present invention illustrating the removability of the disposable hand piece thereof.

The same reference numerals refer to the same parts through the various figures.

### DESCRIPTION OF THE PREFERRED EMBODIMENT

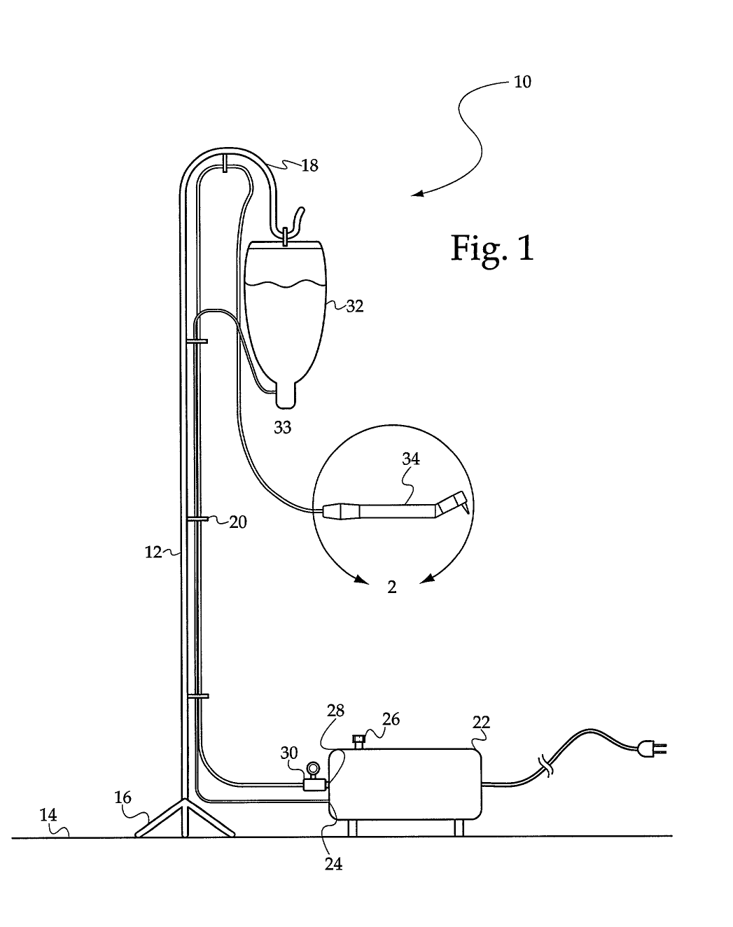

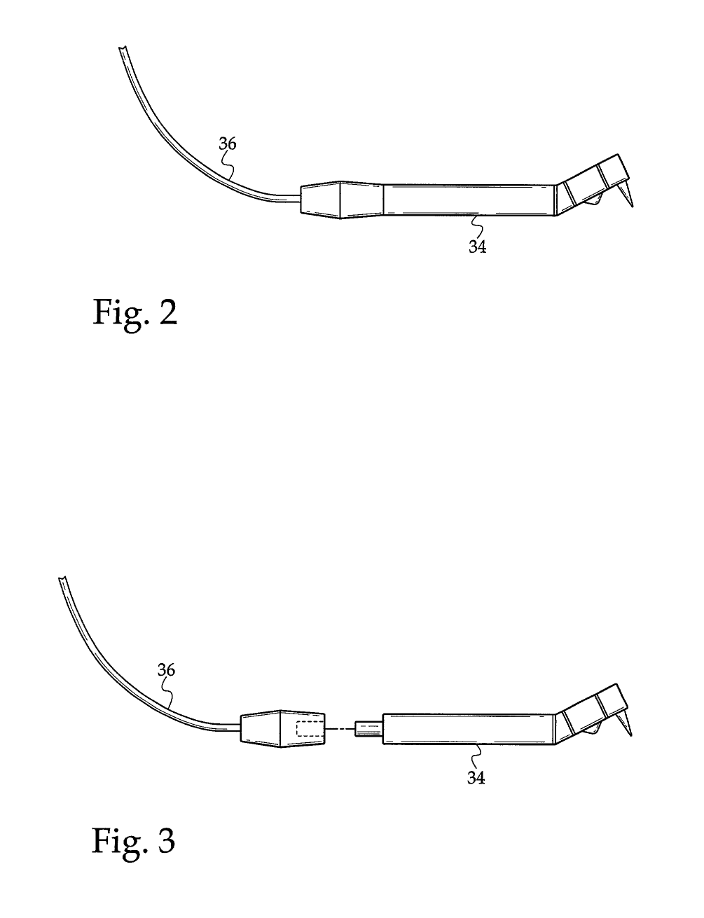

With reference now to the drawings, and in particular, to FIGS. 1 through 3 thereof, the preferred embodiment of the new and improved water and air spray system embodying the principles and concepts of the present invention and generally designated by the reference number 10 will be described.

Specifically, it will be noted in the various Figures that the device relates to a water and air spray system for allowing sterilized water to be sprayed during a dental procedure. In its broadest context, the device consists of a support stand, an air pump, a bottle of sterilized water, and a disposable spray control. Such components are individually configured and correlated with respect to each other so as to attain the desired objective.

The support stand 12 is adapted for being positioned on a recipient surface 14. The support stand 12 has a lower base portion 16 and an upper hooked support portion 18. The support stand 12 includes a plurality of eyelets 20 secured thereto in a spaced relationship extending a length thereof.

The air pump 22 is positioned adjacent to the lower base portion 16 of the support stand 12. The air pump 22 has a water inlet 24 and an air inlet 26. The air pump 22 has a water and air outlet 28. The water and air outlet 28 is also provided with a pressure regulator 30 to insure the safe operation of the present invention.

The bottle of sterilized water 32 is adapted for being removably coupled with the upper hooked support portion 18 of the support stand 12. The bottle of sterilized water 32 has a drain line 33 extending outwardly therefrom for coupling with the water inlet 24 of the air pump 22. The drain line 33 will extend within the eyelets 20 of the support stand 12 to be kept out of the way. The size of the bottle 32 used will depend upon the type of dental procedure being performed and the quantity of water needed. The bottle 32 will be provided with a loop on its upper end to allow for the easy coupling with the upper hooked support portion 18.

The disposable spray control 34 is adapted for spraying water and air therefrom. The disposable spray control 34 has a coupling line 36 removably coupled therewith. The coupling line 36 has a free end coupled with the water and air outlet 28 of the air pump 22. The spray control 34 is capable of spraying air and water into a patient's mouth during a dental procedure. Once the procedure has been completed, the spray control 34 can be discarded to prevent the spread of germs and bacteria.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings. and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A water and air spray system for allowing sterilized water to be sprayed during a dental procedure comprising, in combination:
a support stand adapted for being positioned on a recipient surface, the support stand having a lower base portion and an upper hooked support portion, the support stand including a plurality of eyelets secured thereto in a spaced relationship extending a length thereof;
an air pump positioned adjacent to the lower base portion of the support stand, the air pump having a water inlet and an air inlet, the air pump having a water and air outlet;
a bottle of sterilized water adapted for being removably coupled with the upper hooked support portion of the support stand, the bottle of sterilized water having a drain line extending outwardly therefrom for coupling with the water inlet of the air pump; and
a disposable spray control adapted for spraying water and air therefrom, the disposable spray control having a coupling line removably coupled therewith, the coupling line having a free end coupled with the water and air outlet of the air pump.

2. A water and air spray system for allowing sterilized water to be sprayed during a dental procedure comprising, in combination:
a support stand adapted for being positioned on a recipient surface;
an air pump positioned adjacent to the support stand, the air pump having a water inlet and an air inlet, the air pump having a water and air outlet;
a bottle of sterilized water adapted for being removably coupled with the support stand, the bottle of sterilized water having a drain line extending outwardly therefrom for coupling with the water inlet of the air pump; and
a disposable spray control adapted for spraying water and air therefrom, the disposable spray control having a coupling line removably coupled therewith, the coupling line having a free end coupled with the water and air outlet of the air pump.
